(19) United States
(12) Patent Application Publication
(10) Pub. No.: US 2007/0169112 A1
(43) Pub. Date: Jul. 19, 2007

(54) Operating program installation method appended with driver program and related structure

(75) Inventors: Ming Chen Wu, Taipei (TW); Chen Pin Lee, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/263,873

(22) Filed: Oct. 31, 2005

(51) Int. Cl. G06F 9/445

(52) U.S. Cl. 717/174

(57) ABSTRACT

An operating system installation method appended with driver programs and related structure is disclosed. The structure, and the method as well, is applied to a computer equipment for appending driver programs needed by hardware units of the computer equipment in an original operating system installation program. The structure includes a loading module, an acquiring module and a mapping module. The method loads an operating system installation into a memory of the computer equipment, maps the driver programs onto system kernel parameters of the operating system installation program to update the operating system installation program, and burns the updated operating system installation program onto a disk, so as to generate an operating system installation disk suit for the hardware units of the computer equipment.

### BACKGROUND OF THE INVENTION

1. Field of the Invention

The present invention relates generally to a program installation method and, more particularly, to an operating system installation method and related structure capable of appending a driver program needed by a hardware unit to an operating system installation program, so as to simplify an installation process and save time.

2. Description of the Background Art

When a computer equipment is executing an operating system installation process, if the computer equipment does not have a storage-related media controller such as a redundant array of independent disk (RAID) controller, a dialogue icon “please input a storage route of a driver program to drive a hardware unit” will pop up. A user then has to insert a floppy stored with the driver program into a floppy disk for the installation program to be executed continuously. However, since most network servers do not include a floppy disk, in order to execute the installation process successfully, the user has to use a mobile disk having a USB interface or a storage media such as an optical disk to access corresponding driver programs, which can be used by the other equipment to execute the installation process. The installation process described above is complicated, and the user, if not having enough computer operation skills, is not expected to be qualified to execute the installation process.

Therefore, it becomes an important issue for a designer to design an operating system installation method and related structure, which is capable of executing the operating system installation quickly and easily.

### SUMMARY OF THE INVENTION

Accordingly, it is an objective of the present invention to solve the aforementioned problems by providing an operating system installation method appended with driver programs and related structure. Therefore a user, even without having enough computer installation skills, can still non-manually execute the driver program of the hare unit easy.

In order to attain the object mentioned above and the others, an operating system installation method appended with driver programs according to the present invention is proposed. The method is applied to a computer equipment having at least a hardware unit. The method includes loading an operating system installation program into a memory of the computer equipment, the operating system installation program comprising a plurality of sub-systems, each of which has a kernel parameter, acquiring driver program information of the hardware unit of the computer equipment; and mapping the acquired driver program information of the hardware unit onto the kernel parameters of the sub-systems of the operating system installation program, and updating the operating system installation program. The driver program of the hardware unit is an original equipment manufacturer (OEM) driver program. The operating system installation program is a disc image file. The method further includes decompressing the updated operating system installation program, so as to generate a corresponding disc image file and burn the disc image file onto a disk, which has an operating system installation program and driver programs. The operating system installation program comprises a boot kernel, a single central processing unit (CPU) kernel, a multiple CPU kernel and a multiple memory kernel. Both the hardware units and their corresponding drive programs have corresponding identification (ID) data.

The structure is applied to a computer equipment including at least a hardware unit. The operating system installation structure includes a loading, module for loading the operating system installation program into a memory of the computer equipment an acquiring module for acquiring the driver program needed by the hardware unit of the computer equipment, and a mapping module for mapping the acquired driver program of the hardware unit onto system kernel parameters of the operating system installation program stored in the memory, and for updating the operating system installation program. The driver program of the hardware unit is an OEM driver program. The operating system installation prod is a disc image file. The method further includes decomposing the updated operating system inflation program, so as to generate a corresponding disc image file and burn the disc image file onto a disk, which has an operating system installation program and driver programs. The operating system installation program comprises a boot kernel, a single CPU kernel, a multiple CPU kernel and a multiple memory kernel. Both the hardware units and their corresponding driver programs have corresponding ID data.

In contrast to the prior art, the operating system installation method appended with driver programs and related structure can be used to generate a specific operating system installation disk for a hardware unit of a computer equipment. A user, even without having enough computer installation skills, can still non-manually execute the driver program of the hardware unit easily. As shown in

### BRIEF DESCRIPTION OF THE DRAWINGS

FIG. 1 is a functional blow diagram of an operating installation structure appended with a driver program of the preferred embodiment according to the present invention.

FIG. 2 is a flow chart of an operating program installation method corresponding to the operating program installation structure shown in FIG. 1.

### DESCRIPTION ON OF THE PREFERRED EMBODIMENT

The following description contains specific information pertaining to the implementation of the present invention. One skilled in the art will readily recognize other advantages and features of the present invention after reviewing what specifically disclosed in the present application. It is ma that the present invention can be implemented and applied in a manner different from that specifically discussed in the present application. It should also be understood that the invention is not limited to the particular exemplary embodiments described herein, but is capable of many rearrangements, modifications, and substitutions with departing from the spirit of the present invention. Wherein, attention that the drawings according to the present invention are all simplified schematic diagrams should be paid to, i.e., they merely illustrate the components pertaining to the inventions and it is not limited to the components what illustrated, the number of the components, shape or proportion of size when actually implementing is a selective design, the layout of the component may be more complex.

The following embodiments further describe the technique means of the present invention in detail, but it is not used to limit the scope of the present invention.

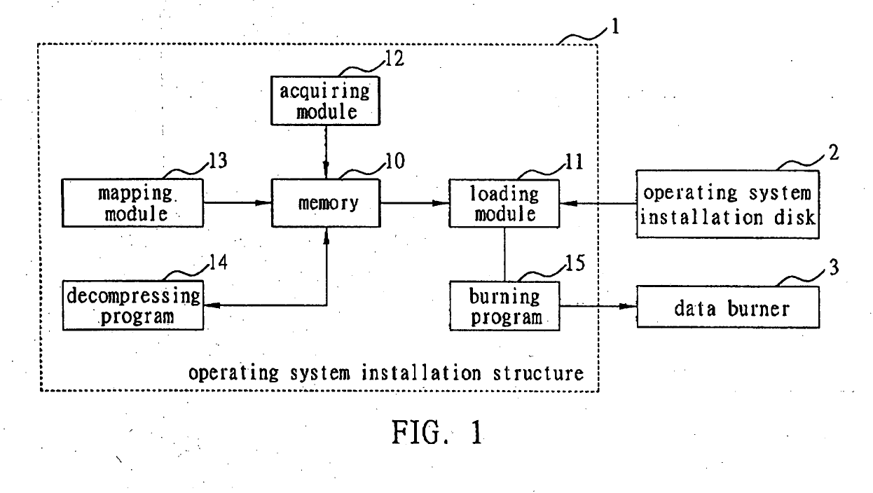

Please refer to FIG. 1, which is functional block diagram of an operating program installation structure 1 of the preferred embodiment according to the present invention. The installation structure 1 is applied to a computer equipment, (not shown) including a plurality of hardware units. The computer equipment is a personal computer or a server. The installation structure 1 is used for integrating and appending driver programs of hardware units attached to the computer equipment to an opening system installation program, so as to generate a combined operating system installation program suit for the computer equipment. Thus, when installing the combined operating program installation program for the computer equipment, the user, even without having enough computer installation skills, can still non-manually execute the driver program of the hardware unit easily. As shown in FIG. 1, the operating system installation structure 1 comprises a memory 10, a loading module 11, a acquiring module 12 a mapping module 13, a decompressing program 14 and a burning program 15. It should be noted that only relevant components of the structure 1 are shown in FIG. 1, other irrelevant components such a an input/output hardware structure; such as keyboard and a monitor, are not shown in FIG. 1.

The memory 10 is a local hard driver, which is used for storing corresponding data generated by a plurality of operating function modules of the structure 1.

The loading module 11 loads an operating system installation program into the memory 10. According to the preferred embodiment, the operating system installation program is a disc image file stored in an operating system installation disk 2

The acquiring module 12 acquires driver programs of the hardware units attached to the computer equipment. According, to the preferred embodiment, the driver program of the hardware unit is an original equipment manufacturer (OEM) provided by manufactures of the hardware unit.

The mapping module 13 maps the driver programs of the hardware units acquired by the acquired module 12 onto system kernel parameters of the operating system installation program stored in the memory 10, to update the original operating system installation program. According to the preferred embodiment, the operating system installation program comprises a boot kernel, a single central processing unit (CPU) kernel, a multiple-CPU kernel and a multiple-memory kernel. Therefore, when the computer equipment is executing a system nation program, the driver programs can be installed in the computer equipment automatically.

It should be noted that both the hardware unit and its corresponding driver program have a corresponding product identification (ID) data, which is set by an equipment manufacturer when they are brought to the market. The ID is product type data or manufacturer code data. Therefore, the computer equipment searches for corresponding driver programs and executes the installation process according to the ID data of the hardware unit, so as to ensure that the hardware unit can unction normally in the computer equipment.

The decompressing program 14 decompresses document formats (that is the disc image file) of the operating system installation program burned onto the disks and compresses the updated operating system inflation program into a document in the format of the disc image file.

With a data burner 3 installed in the computer system, the burning program 15 compasses the decompressing program 14 into a document in a format of the disc image file and burns the formatted program 14 onto a disk so as to generate an operating system installation disk having the diver program of the hardware unit.

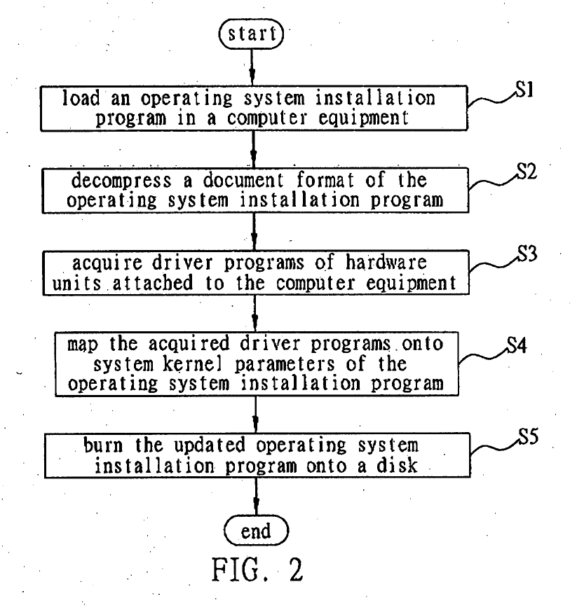

Please refer to FIG. 2, which is a flow chart of an operating system installation method according to the present invention. The method of the present invention is applied to a computer equipment comprising a plurality of hardware units. As shown in FIG. 1, step S1 is a start step of the method. In step S1, an operating system installation program stored in an operating system installation disk 2 is reads and is stored in the memory 10 of the computer equipment.

In step S2 which is executed after step S1, the decompressing program 14 is executed, and the document format of the operating system installation program, that is the disc image file, is decompressed.

In step S3, which is executed after step S2, driver program of the hardware units attached to the computer equipment are acquired. The driver programs of the hardware units arm the OEM driver programs provided by the manufacturer. Both the hardware units and their corresponding driver programs have corresponding ID data. Therefore, the computer equipment searches for corresponding driver programs and executes the installation press according to the ID data of the hardware units.

In step S4, which is executed after step S3, the acquired driver programs of the hardware units are mapped onto the system kernel parameters of the operating system installation program, so as to update the operating system installation program. According to the embodiment, the system kernels comprise a boot kernel, a single CPU kernel, a multiple-CPU kernel and a multiple-memory kernel.

In step S5, which is executed after step S4, the decompressing program 14 is executed to compress the updated operating system installation program, so as to generate a corresponding disc image file document. In step S5, the burning program 15 is executed, and the data burner 3 attached to the computer equipment burns the document onto a disk, so as to generate an operating system installation disk suit for the computer equipment.

In a process that the operating system installation disk generated by the computer equipment of the present invention executes the operating system installation process, when an action that the driver programs of the hardware units are scanned and installed, the driver programs having corresponding ID data can be found by the installation program according to the ID data of the hardware unit. Therefore, the operating system installation program can be executed successfully.

Therefore, The operating system installation method and related structure, both of which have appended driver programs, are capable of generating an emoting system installation disk for a computer equipment of a specific type. In result, in the operating system installation process, the computer equipment needs neither the floppy disk nor the floppy used to store drive programs, and a user, even without having enough computer installation skills, can still non-manually execute the driver program of the hardware unit easily.

The above-described exemplary embodiments are to describe various objects and features of the present invention as illustrative and not restrictive of the scope of the essential technical content according to the present invention, the essential technical content of the present invention is broadly defined in the appended claim, if the exemplary embodiments or method implemented by any one are completely identical to the following claim or only an equivalent change of the following claim, all that is considered to fall with the scope of the invention.

What is claimed is:

1. An operating installation-method appended with a driver program, the operating system installation method being applied to a computer equipment having at least a hardware unit, the operating system installation method comprising:
loading an operating system installation program into a memory of the computer equipment, the operating system installation program comprising a plurality of sub-systems, each of which has a kernel parameter;
acquiring driver program information of the hardware unit of the computer equipment; and
mapping the acquired driver program information of the hardware unit onto the kernel parameters of the sub-systems of the operating system installation program, and updating the operating system installation program.

2. The operating system installation method of claim 1, wherein the driver program of the hardware unit is an original equipment manufacturer (OEM) driver program.

3. The operating system installation method of claim 1, wherein the operating system installation program is a disc image file.

4. The operating system installation method of claim 1, wherein the operating system installation program comprises a boot kernel, a single central processing unit (CPU) kernel, a multiple CPU kernel and a multiple memory kernel.

5. The operating system installation method of claim 1, wherein the computer equipment is selected from a group consisting of a computer (PC) and a server.

6. An operating system installation structure appended with a driver program the operating system installation structure being applied to a computer equipment having at least a hardware unit or loading a driver program corresponding to the hardware unit into an operating system installation program, the operating system installation structure comprising:
a loading module for loading the operating system installation program into a memory of the computer equipment;
an acquiring module or acquiring the driver prove needed by the hardware unit of the computer equipment; and
a mapping module for mapping the acquired driver program of the hardware unit onto system kernel parameters of the operating system installation program stored in the memory, and for updating the operating system installation program.

7. The operating system installation structure of claim 6, wherein the driver program of the hardware unit is an OEM driver program.

8. The operating system installation method of claim 6, wherein the operating system instillation program is a disc image file.

9. The operating system installation method of claim 6, wherein the operating system installation program comprises a boot kernel, a single CPU kernel, a multiple CPU kernel and a multiple memory kernel.

10. The operating system installation method of claim 6, wherein both the hardware unit and the driver program needed by the computer equipment comprises corresponding product identification information.
